(19) United States
(12) Patent Application Publication
(10) Pub. No.: US 2006/0079117 A1
(43) Pub. Date: Apr. 13, 2006

(54) Wire connecting device

(76) Inventor: Ronald Jerome Voit, Lewiston, NY (US)

Correspondence Address: HODGSON RUSS LLP, ONE M & T PLAZA, SUITE 2000, BUFFALO, NY, 14203-2391, US

(21) Appl. No.: 11/247,826

(22) Filed: Oct. 11, 2005

Related U.S. Application Data
(60) Provisional application No. 60/616,795, filed on Oct. 8, 2004.

(51) Int. Cl. H01R 13/58

(52) U.S. Cl. 439/465

(57) ABSTRACT

A wire connecting device for the connection of wire or spring element(s) to be aligned and attached to a base frame by the use of shaped cuts and/or catches of the device. The device has sufficient strength to eliminate all base frame pieces other than the single piece side and end slats. A plurality of devices are arranged in parallel, each with a plurality of cuts and/or catches, and are attached to a base frame at positions corresponding to the attachment points of the wire element(s). The wire element(s) is then aligned with the device and with the cuts and/or catches of the device. The wire element(s) is then attached by sliding it such that the attachment points of the element(s) slide into the tight fitting section of the cuts and/or into the catches.

### CROSS-REFERENCE TO RELATED APPLICATION

This application claims the benefit of U.S. Provisional Patent Application No. 60/616,795 filed on Oct. 8, 2004, and entitled “Wire Connecting Device.”

### FIELD OF THE INVENTION

The invention relates generally to bedding, and more particularly to a wire connecting device for use as a slat in a bedding foundation.

### BACKGROUND OF THE INVENTION

A conventional mattress foundation, sometimes referred to as a “box spring,” comprises a generally rectangular and typically wooden frame as the base, and a generally rectangular core wire grid assembly spaced above the wooden frame by a plurality of coil wire and/or springs. The coil wire and/or springs of the core wire grid assembly are attached to the wooden frame during manufacture. In this process the plurality of springs or a plurality of points of a spring assembly are fastened to a base typically made of several pieces of wood. This assembly is in general achieved by the use of staples, a plurality of which are used at each attachment point of which there are a plurality of attachment points, often in a location at which it is awkward to position a stapler. This process can be awkward, inefficient, difficult, time-consuming, labor intensive, and uneconomical.

An example of a wire grid assembly that may be stapled to slats is shown and described in U.S. Pat. No. 5,052,064, which is hereby incorporated by reference. Referring to FIGS. 1-3, a nestably stackable assembly 104 comprises a rectangular steel border wire 110 having two parallel sides 111 and two parallel ends 112 with the parallel sides 111 being longer than the parallel ends 112. Transversely-spaced, parallel, and longitudinally-extending steel support wires 113 are parallel to the border wire sides 111 and have ends 114 which are crimped around the ends 112 of the border wire 110. These support wires 113 are formed so as to be generally corrugatedly-shaped along their lengths, having peaks 115 and valleys 116. These peaks 115 and valleys 116 are flattened at their extrememost locations 117 and 118, respectively. These flattened peaks 117 are generally coplanar with the plane defined by the border wire 110, with the flattened valleys 118 being vertically spaced beneath and intermediate of the flattened peaks 117. Longitudinally-spaced, parallel, and transversely-extending steel upper connector wires 119 extend parallel to the border wire ends 112 and have ends 120 which are crimped around the border wire sides 111. These upper connector wires 119 are welded intermediate of their ends along their lengths 121 to the flattened peaks 117 of the support wires 113. Longitudinally-spaced, parallel, and transversely-extending steel lower connector wires 122 extend parallel to the border wire ends 112 and are welded at their ends 123 and intermediate of their ends along their lengths 124 to the flattened valleys 116 of the support wires 113.

Referring now to FIG. 2, the support wires 113 have flattened peaks 117 and flattened valleys 118, with the support wire ends 114 being crimped around the border wire 110. In this embodiment, three upper connector wires 119 per flattened peak 117 are illustrated, along with one lower connector wire 121 per flattened valley 118. The flattened valleys 118 of the support wires 113 are stapled or otherwise attached to the transverse slats 103 which are in turn affixed to the base frame 102. If desired, additional steel end wires 125 may be added either before or after the stackable assembly 104 has reached its final assembly destination. These end wires 125 have ends 126 and 127 which are crimped around the border wire 110 and the endmost upper connector wire 128, respectively. These end wires 125 provide additional stiffness to the stackable assembly 104 in an edgemost location of the ends of the assembly 104 so as to prevent the end border wires from deflecting and being permanently distorted when a person sits on the end of a bed of which the foundation forms a part. The metal core portion of a bedding foundation is generally manufactured by a supplier, who then ships it to an assembler. The assembler adds to the metal core a wooden base 102, slats 103, padding 105, and upholstery 106 to make a completed product. The invention of this application facilitates shipment of the metal core or stackable assembly by a supplier to the assembler. With reference to FIG. 3, it will be seen that a first stackable assembly or core 104 may be placed upon a surface with the flattened valleys 118 of the support wires 113 oriented downwardly and the flattened peaks 117 of the support wires 113 oriented upwardly. Next, a second like assembly 104 is placed atop the first assembly 104, with its flattened support wire valleys 118 and flattened support wire peaks 117 likewise oriented downwardly and upwardly, respectively. The flattened valleys 118 of the second assembly 104 are thereby allowed to enter into the voids between the flattened peaks 117 of the first assembly 104. The second assembly 104 nestles downwardly within the first assembly 104 until the outside dimension of the valleys 101 of the second assembly 104 is equal to the inside dimension of the valleys 116 of the first assembly 104. At this point, the second assembly 104 comes to rest within the first assembly 104, with the overall height of the nested assemblies being substantially less than the sum of the individual heights of the assemblies. Of course, any number of assemblies may be nested and stacked together for storage or shipment.

The stapling of a wire grid assembly to the slats requires the action of aligning and stapling many times over and is thus inefficient, difficult, time-consuming, labor intensive, awkward and not economical. What is needed is a improved structure for attaching the spring assembly to the base.

### SUMMARY OF THE INVENTION

The present invention meets the above described need by providing an improved device for attaching a core wire grid assembly (coil wire or springs) to a base, which can be made of wood, plastic, metal, or a combination thereof.

The present invention includes the use of slot shaped cuts, grooves or catches attached to or made into slats for the alignment and attachment of wire or other thin elements and the support thereof. This invention is useful in the manufacture of mattress foundations and other products where a plurality of elements or a plurality of points of an element need to be aligned and attached to a base. The following invention allows for simultaneous alignment and attaching of a plurality of elements or a plurality of points of an element in one quick step, thereby making the attachment process less difficult, less time-consuming, less awkward, less labor intensive and more economical than alternate processes such as stapling.

### BRIEF DESCRIPTION OF THE DRAWINGS

The invention is illustrated in the drawings in which like reference characters designate the same or similar parts throughout the figures of which:

FIG. 1 is a perspective view, partially broken away, of a prior art bedding foundation assembly;

FIG. 2 is a view taken along lines 2-2 of FIG. 1 illustrating the corrugatedly formed support wires and optional end connection wires;

FIG. 3 is a view like FIG. 2 but illustrating two unmounted foundations stacked and nested one within the other for shipment;

FIG. 4 is a perspective view of the wire connecting device of the present invention attached to a base frame;

FIG. 5 is an exploded view of the wire connecting device and a base frame;

FIG. 6 is a perspective view of the base frame;

FIG. 7 is a perspective view of a single cross-member;

FIG. 8 is a view like FIG. 7, but illustrating two un-mounted cross-members nested one inside the other;

FIG. 9 is a perspective view of the cross-member and the attachment point of an element that will be placed in the V-shaped cut and catch;

FIG. 10 is a perspective view of the cross member and the attachment point of an element after being placed in the V-shaped cut and catch;

FIG. 11 is a perspective view of different catch shapes;

FIG. 12 is a perspective view of different cut shapes;

FIG. 13 is a perspective view of a base frame with mounted slats and a semi-flexible element to be attached; and

FIG. 14 is a perspective view of a base frame with mounted slats and a semi-flexible element attached.

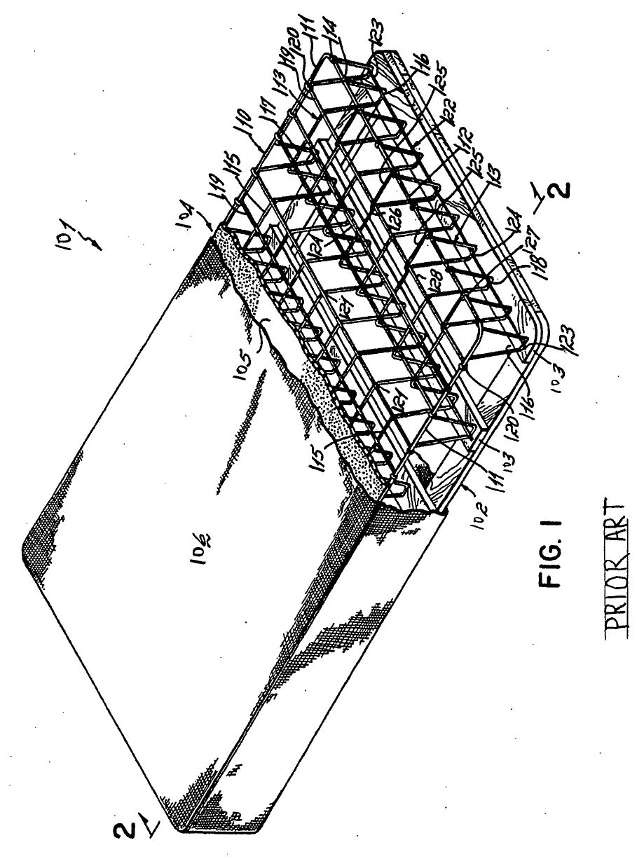

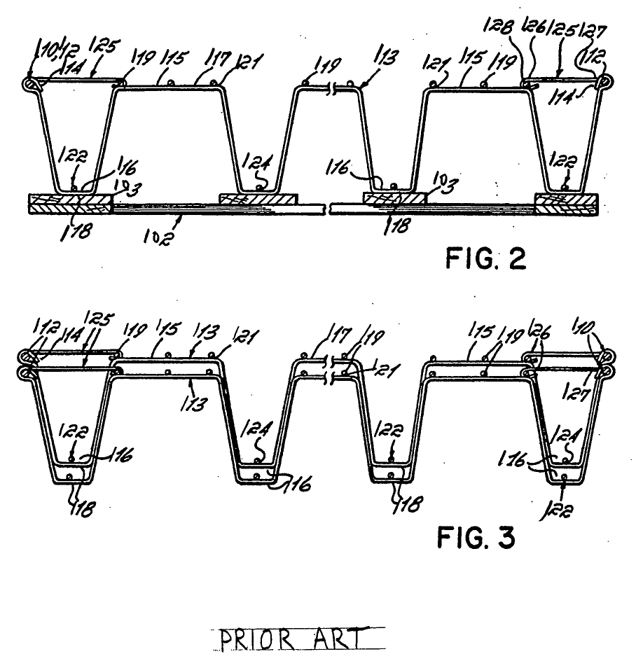

### DETAILED DESCRIPTION

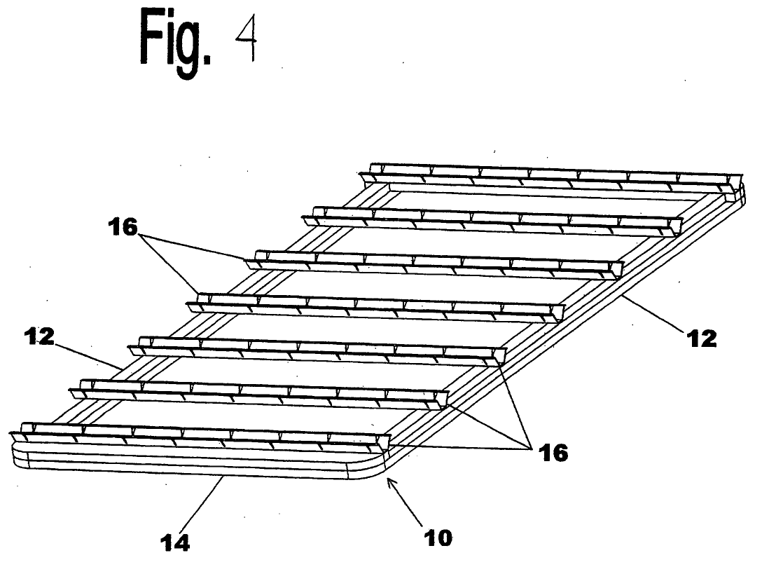

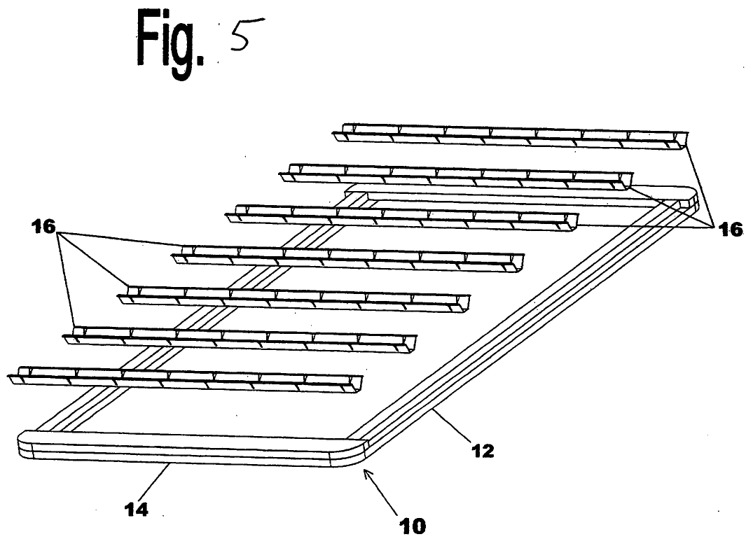

Referring to FIG. 4, a base frame 10 of a mattress foundation is illustrated. The base frame 10 is generally rectangular consisting of side slats 12 and end slats 14. The frame 10 also includes transversely mounted generally U-shaped slats 16. These slats 16, which can be used in any number and are typically arranged in parallel, are the wire connecting device of the present invention.

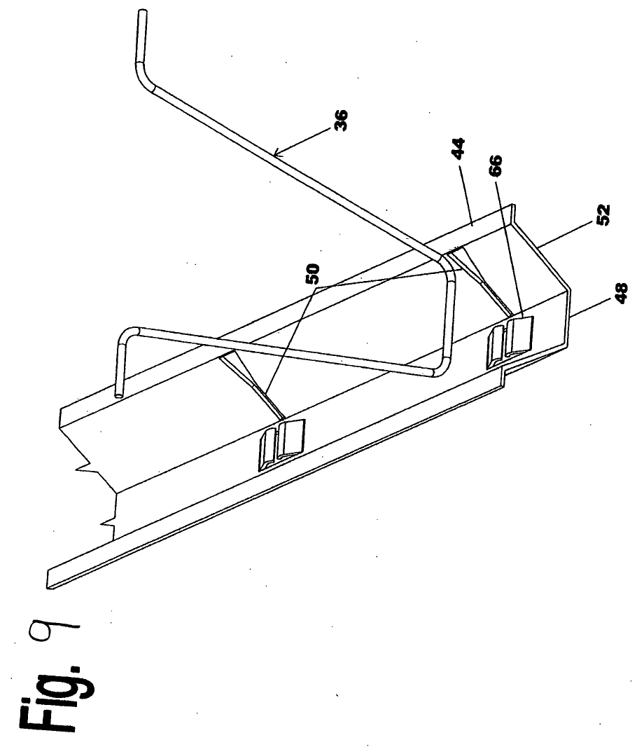

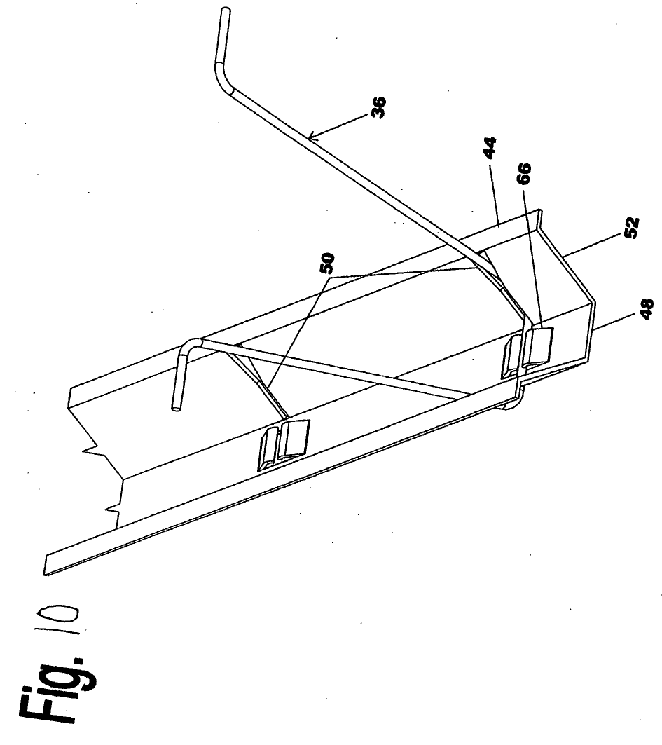

The slats 16 may be generally U-shaped in cross-section allowing for them to be stacked or nested within each other during shipment or storage as shown in FIG. 8. The U-shape provides for generally upright walls 52 (best shown in FIG. 9) that allow the slat 16 to be stronger or more load bearing. Alternately, a slat may not have walls 52 or may not be completely load bearing but could be mounted on a load bearing surface. Additional strength can be added with various features such as the top flanges 44 (FIG. 9) at the top of the upright walls 52. Both added material and added bends of the material tend to add to the strength and rigidity of the slat 16.

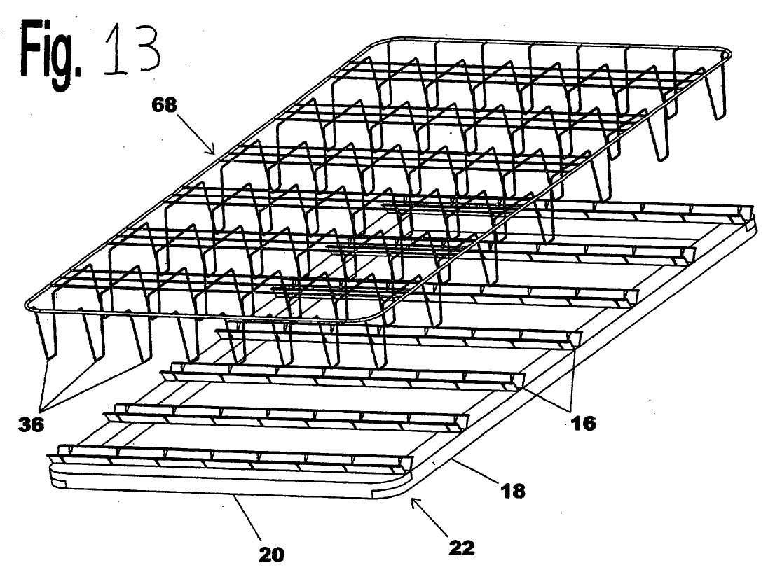

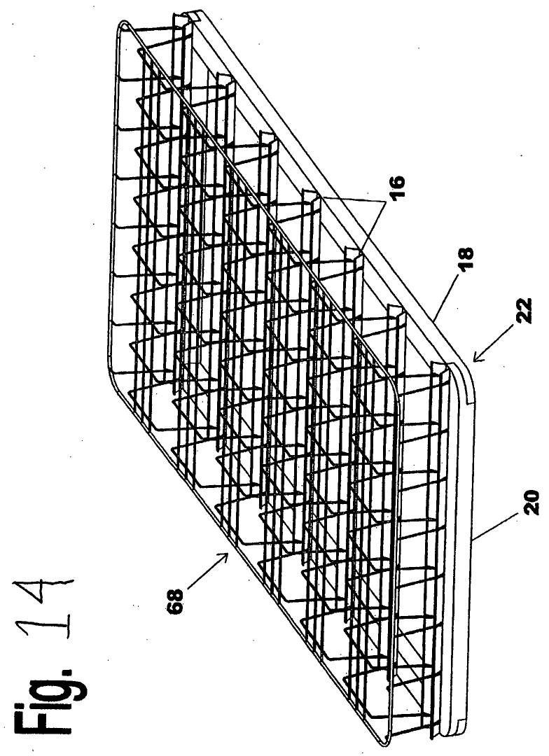

The purpose of the slats 16 is to align and/or attach wire parts or other thin elements to the base frame 10, which is generally made of wood but can be made of wood, plastic, metal or a combination thereof. The wire element(s) 68 of base frames shown in FIG. 13 and FIG. 14 are known in the industry and commercially available from Leggett & Platt, Incorporated in Carthage, Mo.

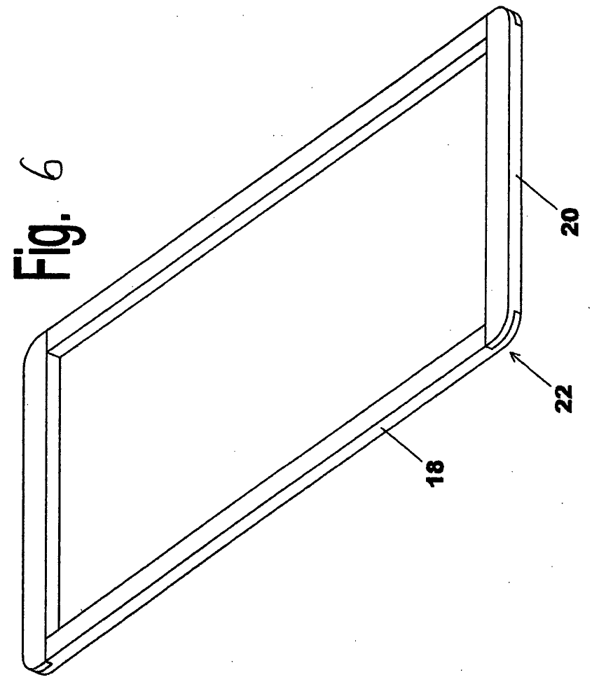

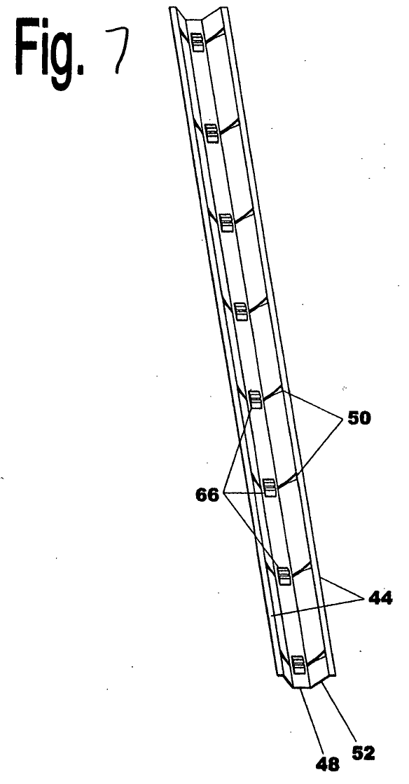

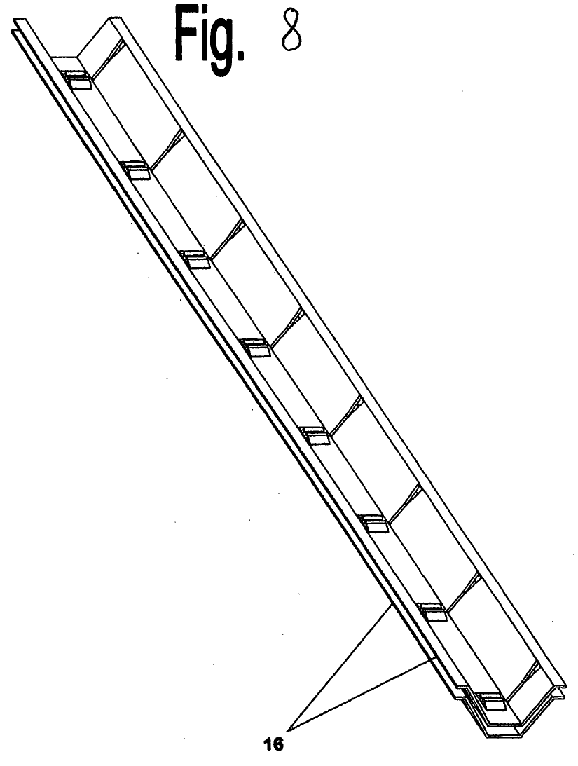

Slats 16 are connected to the base frame 10 by use of staples, screws, nails or any other suitable fastening method, and the slats 16 are generally arranged in parallel. The slats 16 are connected to the side slats 12 and the end slats 14. Optional additional pieces may link the side slats 12 or end slats 14 or any combination of these. U-shaped slats 16 are generally of sufficient strength to eliminate the need for any base pieces other than the side slats 12 and end slats 14. This allows for a unique design for a base frame 22 as shown in FIG. 6 to be used, with a single piece of material for each side slat 18 and end slat 20. This unique base frame 22 eliminates the long cuts needed to create two distinct boards for each side slat 12 and end slat 14 of a traditional base frame design, removes the time and labor of stapling two boards together to create each side slat 12 and end slat 14 and reduces the material used.

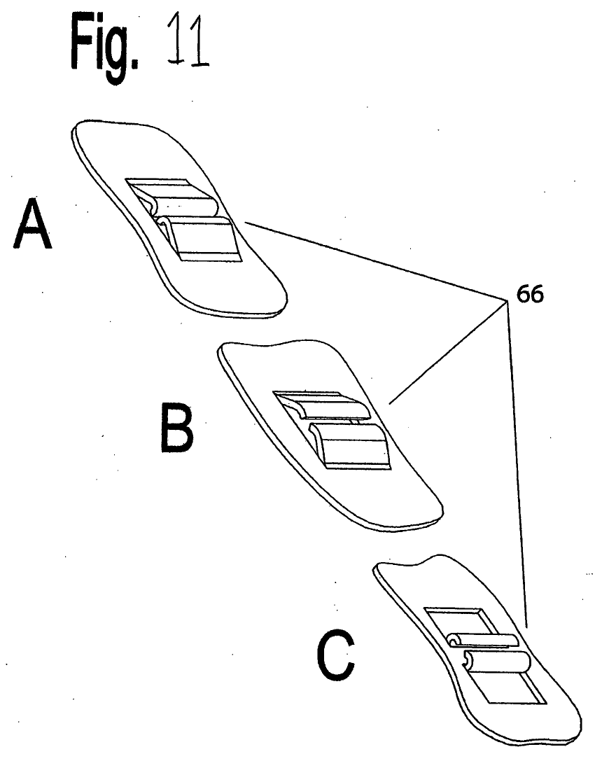

A plurality of slats 16 can be used to secure each element 68 as shown in FIG. 13 and FIG. 14 or each attachment point of an element 36 as shown in FIG. 9 and FIG. 10. Slats 16 can extend for any length and contain any combination of cuts 50, grooves or catches 66 to hold the element(s) 68.

The cuts 50, grooves and catches 66 are the features which provide for the alignment and attachment of the element(s) 68. A slat 16 can contain any number or combination of cuts 50, grooves and/or catches 66, singly, in pairs or in any arrangement in order to securely attach the element 68.

Cuts 50 (best shown in FIG. 9) are a feature generally located on the upright wall 52, but can be located on the base 48 of the slat 16 or any other feature, and can extend partially or fully through the wall 52 of the slat 16 or the base 48 of the slat 16. Cuts 50 may be made by cutting, punching out or otherwise removing the material of the slat 16 or material attached to a slat 16.

A groove generally has a shape like that of a cut 50, but differs in that it may be made by bending or folding the slat 16 material, adding material or cutting material to form a shape that allows for the attachment of an element 68 in a manner similar to that of a cut 50. As both cuts 50 and grooves are used and function identically, and can be used in place of each other, they will both be referred to and should be considered to be cuts 50.

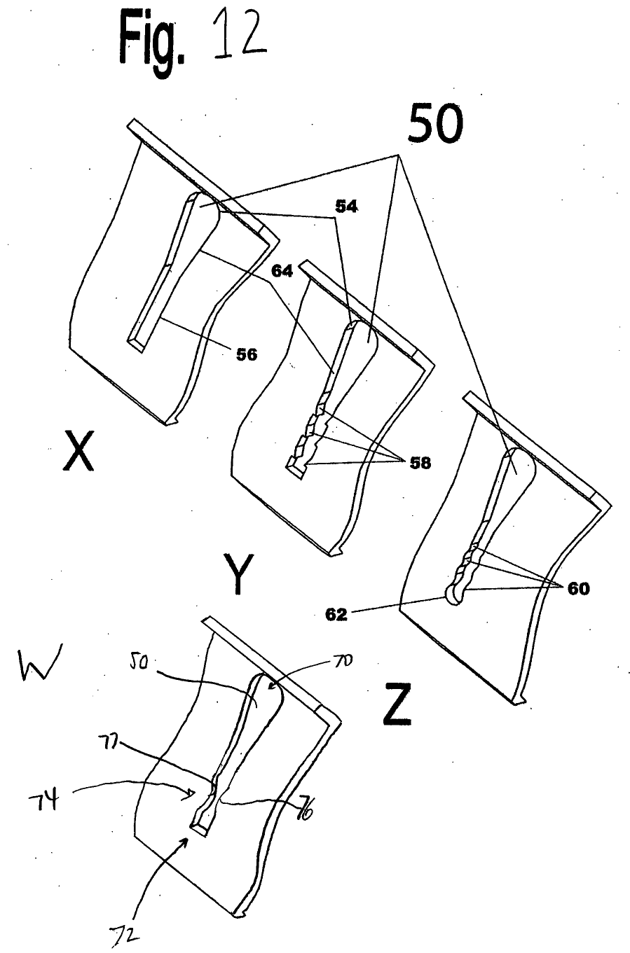

Cuts 50 are generally V-Shaped or contain a V-shape 64, as shown by reference X of cut 50 in FIG. 12, leading to a straight section 56 or with any sort of shape such that the element(s) 68 is easily aligned in position and attached in place. Generally, the width of the V-shape 64 is such that the element(s) 68 easily fit into a part of the cut 50 and fit tightly into another part of the cut 50. The shape of the cuts 50 can contain features such as holes 62, as contained in reference Z for cut 50, waves 60 also contained in reference Z for 50, teeth 58 as contained in reference Y for cut 50 or any other such feature to increase the ease of alignment or the grip and hold on the element(s) 68. Cuts 50 may have rounded corners 54, especially at their top or bottom which generally increases the strength of the slat 16. Cuts 50 can extend the entire height of the wall 52 or width of the slat base 48 or extend not fully to the top, bottom and/or edges. Referring to Reference W at the bottom of FIG. 12, the cut 50 may be formed with a larger opening 70 at the top and a narrower opening 72 at the bottom. The two openings may be connected by a section 74 with a pair of inward curved walls 76, 77 disposed in facing relation.

Optional catches 66 may be used by themselves, in combination with other catches 66 or in addition to cuts 50 to align the element(s) 68 or provide additional hold. Catches 66 may be made by cutting and/or bending (away from the base 48 of the slat 16 or wall 52) of the slat 16 material or material attached to the slat 16. Generally, the attachment point of an element 36 is positioned between two facing halves of a catch 66 or between a catch 66 and itself or the catch 66 and the rest of the slat 16.

Catches can be made in any shape that aids alignment or increases hold on the element(s), such as catch 66A or 66B, shown in FIG. 11, where the catch is made from cutting and bending back the slat material. Catches can also be made by cutting and bending slat material together such as in catch 66C or by any other method which will align and/or hold the element(s) 68.

The element(s) 68 to be attached can be easily aligned within the walls 52 of the slat 16, if the slat 16 has walls 52 and in the V-shaped cuts 50 and/or catches 66 in the slat 16, completing alignment. Exerting a downward force on the element(s) 68 to be attached will then cause it to slide into the V-shaped cuts 50 and due to a tight fit, the optional use of gripping shapes of the cut 50 and/or catches 66 on the slat 16, the element(s) 68 will be held in position and attached to the slats 16 and the connected base frame 10.

A bedding foundation may be formed according to the present invention in the following manner. The frame 10 is assembled by attaching the ends 20 to the sides 18. Additional cross braces may be added for additional support. The wire grid assembly 68 is placed on a flat surface with the flattened valleys facing upward. The slats or wire connecting devices 16 of the present invention are aligned such that the flattened valleys align with the slots 50 in the wire connecting devices 16. Next, a blunt object is used to strike down on the slats 16 to cause the wire elements 68 to enter the slots 50 formed in the side walls 52. Alternatively, the slats 16 can be pushed onto the wire elements 68 by hand. The wire elements 68 snap into position and the slats 16 are thereby attached to the wire grid assembly. Finally, the slats 16 are attached to the frame 10 to form the bedding foundation subassembly of the present invention.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A wire connecting device for attaching a wire grid assembly to a base for a bedding foundation, the wire connecting device, comprising:
a first wall having at least one first slot defined therein;
a second wall having at least one second slot defined therein, the second slot disposed opposite from the at least one first slot in facing relation;
an intermediate wall extending between the first wall and the second wall; and,
the first wall and second wall disposed at an angle with respect to the intermediate wall.

2. The wire connecting device of claim 1, wherein the angles between the first wall and the intermediate wall and the second wall and the intermediate wall are approximately equal and opposite.

3. The wire connecting device of claim 1, wherein the at least one first slot has a first end and a second end, the width of the slot at the first end being greater than the width of the slot at the second end such that the at least one first slot is capable of receiving a portion of the wire grid assembly in sliding relation.

4. The wire connecting device of claim 1, wherein one of the at least one first slot and at least one second slot is formed by an opening in one of the first and second wall.

5. The wire connecting device of claim 1, wherein one of the at least one first slot and at least one second slot is formed by a groove disposed in one of the first and second wall.

6. The wire connecting device of claim 1, wherein one of the at least one first slot and at least one second slot is bordered by a curved surface.

7. The wire connecting device of claim 1, wherein one of the at least one first slot and at least one second slot is bordered by a serrated surface.

8. The wire connecting device of claim 1, wherein one of the at least one first slot and at least one second slot has a first end that is wider than a second end and has a pair of facing concave surfaces disposed between the first and second end.

9. The wire connecting device of claim 1, wherein one of the at least one first slot and at least one second slot has a plurality of concave surfaces disposed therein.

10. The wire connecting device of claim 1, wherein one of the at least one first slot and at least one second slot has a plurality of alternating concave and convex surfaces disposed thereon.

11. The wire connecting device of claim 1, wherein one of the at least one first slot and at least one second slot has a section with a straight wall.

12. The wire connecting device of claim 1, wherein one of the at least one first slot and at least one second slot has a first end and a second end, the second end being bordered by a curved edge.

13. The wire connecting device of claim 1, wherein one of the at least one first slot and at least one second slot has a first end and a second end, the second end being bordered by substantially straight walls.

14. A bedding foundation, comprising:
a base frame comprising at least two side members and a least two end members;
at least one slat extending between the side members the slat comprising a first wall having at least one first slot defined therein, a second wall having at least one second slot defined therein, the second slot disposed opposite from the at least one first slot in facing relation, an intermediate wall extending between the first wall and the second wall, the first wall and second wall being disposed at an angle with respect to the intermediate wall; and,
a wire grid assembly having a border wire and a plurality of support wires, the support wires capable of being received in the at least one first slot and at least one second slot for attaching the wire grid assembly to the at least one slat.

15. The bedding foundation of claim 14 wherein the support wires comprise a lower portion in the shape of a flattened valley.

16. The wire connecting device of claim 14, wherein the angles between the first wall and the intermediate wall and the second wall and the intermediate wall are approximately equal and opposite.

17. The wire connecting device of claim 14, wherein the at least one first slot has a first end and a second end, the width of the slot at the first end being greater than the width of the slot at the second end such that the at least one first slot is capable of receiving a portion of the wire grid assembly in sliding relation.

18. The wire connecting device of claim 14, wherein one of the at least one first slot and at least one second slot is formed by an opening in one of the first and second wall.

19. The wire connecting device of claim 14, wherein one of the at least one first slot and at least one second slot is formed by a groove disposed in one of the first and second wall.

20. The wire connecting device of claim 14, wherein one of the at least one first slot and at least one second slot is bordered by a curved surface.

21. The wire connecting device of claim 14, wherein one of the at least one first slot and at least one second slot is bordered by a serrated surface.

22. The wire connecting device of claim 14, wherein one of the at least one first slot and at least one second slot has a first end that is wider than a second end and has a pair of facing concave surfaces disposed between the first and second end.

23. The wire connecting device of claim 14, wherein one of the at least one first slot and at least one second slot has a plurality of concave surfaces disposed therein.

24. The wire connecting device of claim 14, wherein one of the at least one first slot and at least one second slot has a plurality of alternating concave and convex surfaces disposed thereon.

25. The wire connecting device of claim 14, wherein one of the at least one first slot and at least one second slot has a section with a straight wall.

26. The wire connecting device of claim 14, wherein one of the at least one first slot and at least one second slot has a first end and a second end, the second end being bordered by a curved edge.

27. The wire connecting device of claim 14, wherein one of the at least one first slot and at least one second slot has a first end and a second end, the second end being bordered by substantially straight walls.

28. A method of assembling a bedding foundation, the method comprising:
providing a base frame comprising at least two side members and a least two end members;
providing a plurality of slats comprising a first wall having at least one first slot defined therein, a second wall having at least one second slot defined therein, the second slot disposed opposite from the at least one first slot in facing relation, an intermediate wall extending between the first wall and the second wall, the first wall and second wall being disposed at an angle with respect to the intermediate wall;
providing a wire grid assembly having a border wire and a plurality of support wires, the support wires having a proximal portion adjacent to the border wire and having a distal portion disposed in spaced apart relation to the border wire, the distal portion of the support wires capable of being received in the at least one first slot and at least one second slot for attaching the wire grid assembly to the at least one slat;
placing the wire grid assembly on a flat horizontal surface such that the distal portion of the support wires is facing upward;
placing the plurality of slats over the wire grid assembly such that the distal portion of the support wires aligns with at least one first slot and at least one second slot;
attaching the slats to the wire grid assembly such that the distal portion of the support wires slides into the slots; and,
attaching the slats to the frame to form a bedding foundation subassembly.
